(19) United States
(12) Patent Application Publication
(10) Pub. No.: US 2003/0233259 A1
(43) Pub. Date: Dec. 18, 2003

(54) Medicare enrollment processing

(76) Inventors: Anthony Mistretta, Alpharetta, GA (US); Peter Keohane, Alpharetta, GA (US)

Correspondence Address: LITTMAN LAW OFFICES, LTD., P.O. BOX 15035 CRYSTAL CITY STATION, ARLINGTON, VA, 22215, US

(21) Appl. No.: 10/170,363

(22) Filed: Jun. 14, 2002

(51) Int. Cl. G06F 17/60

(52) U.S. Cl. 705/4

(57) ABSTRACT

A Medicare enrollment processing computer system automates the completion of voluminous, new, Medicare enrollment forms, to be introduced in 2002. Required by the United States Centers for Medicare and Medicaid Services, the forms are designated 855A, 855B, 855I, 855R, and 855S. The present invention leads the use through a series of questions that are presented in a graphical user interface. As the user answers the questions, the program validates the data entered by the user to make sure that the information is appropriate for a given field. The invention prevents users from omitting required data. In addition, the instant invention automatically inserts redundant data in appropriate fields, eliminating manual reentry of data.

### BACKGROUND OF THE INVENTION

1. Field of the Invention

The present invention relates to automated data processing and in particular to automated Medicare enrollment forms. The present invention is a computer program having a simplified user interface and central data storage. The program takes data from the user and outputs completed Medicare enrollment forms. The software validates data to make sure it is appropriate for a given field and automatically inserts redundant data in appropriate fields, eliminating manual reentry of data.

The instant invention is required because new Medicare enrollment requirements to be introduced this year are extremely burdensome and because there is no other software that adequately automates filling out the forms.

2. Description of the Related Art

No prior art duplicates the instant invention.

Only one product is similar to the present invention, and that product is not patented. The United States Centers for Medicare and Medicaid Service (CMS) supplies electronic versions of Medicare enrollment forms, which can be downloaded from the Internet. These forms fall far short of the automation and convenience of the instant invention.

Each CMS electronic form must be completed separately, and the data is stored with the form. There is no central storage of data and no sharing of data among forms. The user must enter redundant data anew in every form.

In addition, CMS electronic forms have only bare-minimum data validation. CMS electronic forms only check for fields that have been left empty. Even when the CMS program catches these errors, it gives a cryptic error message and points to the problem field, giving no further assistance.

The present invention has strong, intelligent validation, and tells the user the nature of a mistake. In addition, the present invention tells the user how to correct a mistake. As an added safety precaution, in some cases, the present invention does not permit the user to enter erroneous information.

The instant invention also takes into account the logical situation. For example, based on the answer to a given question, subsequent sections of the form may not apply to a particular provider. The present invention does not allow the user to enter data into these inappropriate subsequent sections. In contrast, CMS electronic forms freely allow the user to enter mistaken information. When such errors are made, the government returns the form to the provider for correction. As a result, payment for services rendered can be delayed.

If the instant invention discovers an error when it validates a form, it not only spells out the discrepancy in plain English, but often provides clarification and advice on how to resolve the problem. In addition, the present invention provides help screens with explanatory information. The CMS program has no such help screens.

U.S. Pat. No. 5,930,759, issued on Jul. 27, 1999, to James G. Moore and Wayne E. Jones, titled “Method and System for Processing Health Care Electronic Data Transactions,” automates health-insurance claims, but applies only to patients and has nothing to do with enrolling health-care providers in Medicare.

U.S. Pat. No. 6,012,035, issued on Jan. 4, 2000 to Berkley Irving Freeman, Jr. and Edgar William Smith, titled “System and Method for Supporting Delivery of Health Care,” concerns linking health-care providers, including insurance companies, in a data-communications network and expediting financial transactions. The Freeman invention, again, has nothing to do with Medicare enrollment or the new Medicare-enrollment forms.

U.S. Pat. No. 6,112,183, issued on Aug. 29, 2000, to Michael L. Swanson et al., titled, “Method and Apparatus for Processing Health Care Transactions Through a Common Interface in a Distributed Computing Environment,” automates billing for healthcare procedures, uses a graphical user interface, and links networks of health-care providers, but, once again, does not deal with Medicare or Medicare enrollment forms.

U.S. Pat. No. 5,191,522, issued on Mar. 2, 1993, to James J. Bosco et al, titled “Integrated Group Insurance Information Processing and Reporting System Based Upon an Enterprise-wide Data Structure,” is a computer system for processing and storing health-insurance information, but is intended to administer group-insurance accounts and has no bearing on Medicare enrollment or Medicare enrollment forms.

W.I.P.O. international publication WO 99/41682, issued on Aug. 19, 1999, to David Wayne Johnson et al., titled, “Patient Data Acquisition Unit and Data Support System, ” describes a system for collecting data about patients and storing it in electronic medical forms on a personal digital assistant such as the Palm Pilot. Medicare and Medicare enrollment play no role in the Johnson invention.

W.I.P.O. international publication 9430860.0, published on Oct. 5, 1995, by Syed V. Ahamed, titled, “Integrated Computer System and Method for Processing Medical Informations and Patient Data,” describes a computer system for processing medical and patient information in a hospital setting but makes no mention of Medicare or Medicare enrollment forms.

None of the above inventions and patents, taken either singularly or in combination, is seen to describe the instant invention as claimed. Thus a Medicare enrollment processing computer system solving the aforementioned problems is desired.

### SUMMARY OF THE INVENTION

The present invention automates Medicare enrollment in general and in particular automates the completion of voluminous, new, Medicare enrollment forms, to be introduced in 2002. All healthcare practitioners and suppliers who wish to receive Medicare payments must fill out these forms. Required by the United States Centers for Medicare and Medicaid Services, the forms are designated 855A, 855B, 855I, 855R, and 855S.

The present invention is a computer program having a simplified user interface and central data storage. The program leads the user through a series of questions that are presented in a graphical user interface. As the user answers the questions, the program validates the data entered by the user to make sure that the information is appropriate for a given field. In addition, the instant invention automatically inserts redundant data in appropriate fields, eliminating manual reentry of data and saving a great deal of time.

The need for such an invention is great. The U.S. agency responsible for supervising Medicare payments to medical practitioners and suppliers, the Centers for Medicare and Medicaid Services (CMS), has created new enrollment forms to replace its single, old form. Before the end of 2002, CMS will require all Medicare physicians, medical organizations that bill Medicare, and providers of durable medical supplies to Medicare beneficiaries to complete these new forms. One of the new forms, CMS 855A, by itself is 55 pages long.

Most practitioners and institutions will have to complete and submit more than one form. For example, a practice with 10 physicians who are paid by the practice rather than receiving reimbursement directly from Medicare will have to complete one 855B form for the practice; 10 855I forms, one for each physician and each non-physician practitioner; 10 855R forms, one for each provider to reassign his or her Medicare benefits to the practice; and several 855S forms, if the practice dispenses durable medical equipment such as crutches and portable oxygen tanks. The paperwork burden on a hospital, for example, will be immense.

CMS rejects any forms with mistakes in them. The agency will be allowed to hold payment on claims submitted from entities who do not meet the deadlines for submitting acceptably completed 855 forms.

Under the new CMS requirements, five forms replace the single HCFA-855 form. In 2002, Medicare is going to require that all persons and organizations who wish to receive Medicare reimbursement submit their enrollment information again on the five newly created forms. These forms are significantly different from the old form and will require a great deal of time and effort on the part of the representatives of each entity that is assigned to complete the forms. As with any new, complicated, administrative scheme, mistakes are highly likely. Most providers will have to fill out numerous forms for multiple practitioners and purposes. Health-care providers will be under tight deadlines to complete the forms before the end of the year, and the Medicare program will be allowed to withhold payment on claims submitted from entities who do not meet the deadlines for submitting acceptably completed 855 forms.

The present invention validates data that is entered in Medicare-enrollment forms, stores the data for re-use where applicable, and allows users to print out additional completed Medicare-enrollment forms as needed, without re-entering data.

Accordingly, it is a principal object of the invention to automate filling out United States Centers for Medicare and Medicaid Services forms 855A, 855B, 855I, 855R, 855S, and other forms.

It is another object of the invention to minimize confusion and mistakes in filling out the massive Medicare forms by using a simplified, graphical user interface to obtain information from the user.

It is another object of the invention to minimize mistakes in filling out the massive, new Medicare forms by applying internal logic rules to validate the data entered in the graphical user interface by the user.

A further object of the invention is that it alert users to mistakes, telling them the nature of the mistake and how to rectify the error.

Still another object of the invention is that it automatically insert redundant data in appropriate fields, eliminating manual reentry of data and saving a great deal of time.

It is a further object of the invention to enable data entry by computer mouse clicks, voice commands, touch-sensitive screens, tactile-feedback devices, pointing devices, virtual-reality devices, instrument readings, medical monitoring devices, prerecorded data, telemetry, and other techniques as may be developed.

An additional object of the invention is that it output information in paper, electronic, optical, and other forms.

It is another object of the invention to file Medicare enrollment forms 855A, 855B, 855I, 855R, 855S, and other forms, electronically, optically, and otherwise remotely, without recourse to paper.

It is a further object of the invention that it operate on stand-alone computers, on proprietary computer networks, on the Internet and on intranets.

Another object of the instant invention is that it be accessed through its own graphical user interface and through standard, World Wide Web browsers, such as Microsoft Internet Explorer, Netscape, and Opera.

An additional object of the invention is that it store data in a central database.

A further object of the invention is that it prevent users from leaving required fields unfilled.

Another object of the invention is that it allow users to print out copies of completed forms on demand.

Still another object of the invention is that it be independent of the computer platform on which it runs.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a close-up, partial screen shot of the Centers for Medicare and Medicaid Services 855A form.

FIG. 2 is a close-up, partial screen shot of an on-screen, data-entry form.

FIG. 3 is a close-up, partial screen shot of an on-screen, data-entry form.

FIG. 4 is a close-up, partial screen shot of an on-screen, data-entry form.

FIG. 5 is a close-up, partial screen shot of an on-screen, data-entry form.

FIG. 6 is a close-up, partial screen shot of an on-screen, data-entry form.

FIG. 7 is a close-up, partial screen shot of an on-screen, data-entry form.

FIG. 8 is a logic flow chart.

Similar reference characters denote corresponding features consistently throughout the attached drawings.

### DETAILED DESCRIPTION OF THE PREFERRED EMBODIMENT

The present invention automates Medicare enrollment in general and in particular automates the completion of voluminous, new, Medicare enrollment forms, to be introduced in 2002. All health-care practitioners and suppliers who wish to receive Medicare payments must fill out these forms. Required by the United States Centers for Medicare and Medicaid Services, the forms are designated 855A, 855B, 855I, 855R, and 855S.

The present invention is a computer program having a simplified user interface and central data storage. The program leads the user through a series of questions that are presented in a graphical user interface. As the user answers the questions, the program validates the data entered by the user to make sure that the information is appropriate for a given field. In addition, the instant invention automatically inserts redundant data in appropriate fields, eliminating manual reentry of data and saving a great deal of time.

The instant invention facilitates efficient and effective completion of the new Medicare enrollment forms, minimizing hand labor and mistakes. The present invention is a software program built on a database. Because information is stored in a central database, it can be retrieved automatically and inserted in fields where the same data is repeated. The software automatically fills in redundant data, not only between forms of the same type, but between forms of different types, where information such as names and addresses are the same, for example, in a medical practice in which several physicians work in the same location.

The present invention validates data that is entered, stores data for re-use where applicable, and allows users to print out additional completed forms as needed, without re-entering data.

Users include physicians, employees on physician's or hospital's staffs, or an agency acting as an intermediary between individuals or organizations and CMS.

Unique functions of the instant software include strong validation of data entered in required fields, duplication of redundant data among fields and among enrollment forms, centralization of data in one database instead of individual files, and easy printing and viewing.

In the past, physicians, medical institutions, and medical suppliers filled out one, all-inclusive enrollment form, the HCFA-855 form, and submitted it to CMS. A new HCFA-855 had to be completed whenever any of three conditions arose: 1) initial enrollment in the Medicare program to become eligible to receive payments from the Medicare program; 2) when any physician, clinic, hospital, or supplier made any change to the data on file at CMS, including changes of address or phone number, adding a new doctor and overpayment; and 3) leaving the Medicare program.

Under the new CMS requirements, five forms replace the single HCFA-855 form. Form 855A, 55 pages long, is to be completed by Medicare facilities, for example, hospitals; home health agencies; hospices; skilled-nursing facilities; end-stage, renal-disease facilities; comprehensive outpatient rehabilitation facilities; community regional mental-health centers; and rural-health clinics.

Form 855B is to be completed by other types of health-care suppliers, for example, ambulance services, ambulatory surgical centers, Medicare+Choice organizations, independent diagnostic testing facilities, mammography screening centers, single-specialty clinics, and group practices.

Form 855I is to be completed on behalf of individual physicians, non-physician practitioners (nurse practitioners, physicians assistants, certified nurse specialists, clinical psychologists, occupational therapists, and others).

Form 855R is submitted on behalf of physicians and non-physician practitioners who are reassigning their Medicare payments to the practice or other facility.

Form 855S is to be completed for durable medical equipment suppliers, for example, medical supply companies, prosthetic and orthotic suppliers, opticians, grocery stores, and pharmacies who accept Medicare payment for durable equipment.

CMS requires practitioners and suppliers to submit a new form whenever information on any form changes. New forms must be filled out and filed when any of the following conditions apply:

1) when a provider initially enrolls in the Medicare program to become eligible to receive payments from the Medicare program when providing services to Medicare patients.

2) when any change is made to the data that the Medicare program has on file for that entity. Changes include address change, addition of a new doctor or non-physician practitioner, phone number or area code change, overpayment situations, legal actions, any change in group practice information, new location of medical records, office management change, change in billing agencies, updated contract information, new electronic claims submission, and new staffing.

3) when the person or organization no longer wants to accept Medicare reimbursement.

In 2002, Medicare is going to require that all persons and organizations who wish to receive Medicare reimbursement submit their enrollment information again on the five newly created forms.

The instant invention will save Medicare-payment recipients considerable time and effort in several ways. First, each Medicare person and entity will be required to resubmit these forms every three years. Most Medicare-payment recipients will have to complete and submit more than one form. Centralized data storage, such as that employed by the present invention, allows users to efficiently manage this information. When one version of the information is stored in one place, it is much less likely that errors will be introduced when the information is copied again and again, and inserted in form after form.

Second, the new enrollment forms introduce new layers of complexity. Because the old, single form included the data for all different provider types, it was easy for someone filling out the form to become confused about which sections were applicable to the practitioner's circumstances. Filling out the wrong section would usually result in Medicare returning the form for clarification. In that the new forms are separated by intent, the problem of identifying data fields pertinent to the user's situation is eliminated. However, the new forms present new difficulties. The new enrollment forms, and the questions on the new forms, are so complex that it is easy to misconstrue intent or skip relevant sections. The physicians themselves rarely fill out Medicare forms. More often, it is the office manager, credentialing agent, or some other office staff who has the responsibility for compiling the required information.

The instant program is intuitive and makes it easy to find the appropriate form, by provider name or form type, and print it out for submission to CMS. The instant invention also prevents users from leaving required fields unfilled and blocks some types of erroneous data from entering fields. In addition, the software serves up context-based information and advice to users.

Third, Medicare-payment recipients are required to resubmit forms when any significant change is made to the practice profile. The instant invention streamlines the process of making the changes to the appropriate sections of the form and eliminates the possibility of making changes to sections that are not affected. This feature save significant time, in that the user need focus only on the sections that are actually affected by some change.

Fourth, most providers will have to fill out numerous forms for multiple providers and purposes. There are several instances of redundant data. For example, information about the practice listed on form 855B is also found on form 855I. The present invention gives the end user the option of automatically filling in this redundant data. Especially in larger practices and organizations, this feature saves considerable time in filling out the forms. If an administrator must fill out the 855I forms for a dozen physicians, there are numerous places to enter redundant information. For example, all the physicians would share the same practice location, location of the medical records, managing control organization information, and managing employee information. Being able to automatically fill in this data provides a great advantage over completion by typewriter or hand.

The instant invention operates through a standard, Windows-type graphical user interface. A stand-alone application written in FileMaker, the software will be ported to the World Wide Web and other databases, enhancing its availability and ease of use. The program functions primarily on IBM-compatible personal computers, but is designed to be platform independent.

The steps that a user takes to complete one of the new Medicare forms with the instant invention are as follows:

1) Launch the application.

2) Choose to either create a new form from scratch, create a form based on an existing form, modify an existing form, delete a form, view a form, or print a form.

3) Create, modify, delete, or view the form.

4) Print the form if necessary.

The present invention has an easy-to-use graphical user interface that presents the user with familiar on-screen forms and fields, consisting of selection check boxes, option buttons, combo boxes, drop-down lists, tabs, memo fields, scroll bars, menus, and other Windows-type features. The interface resembles the actual paper enrollment forms, but is simpler and clearer.

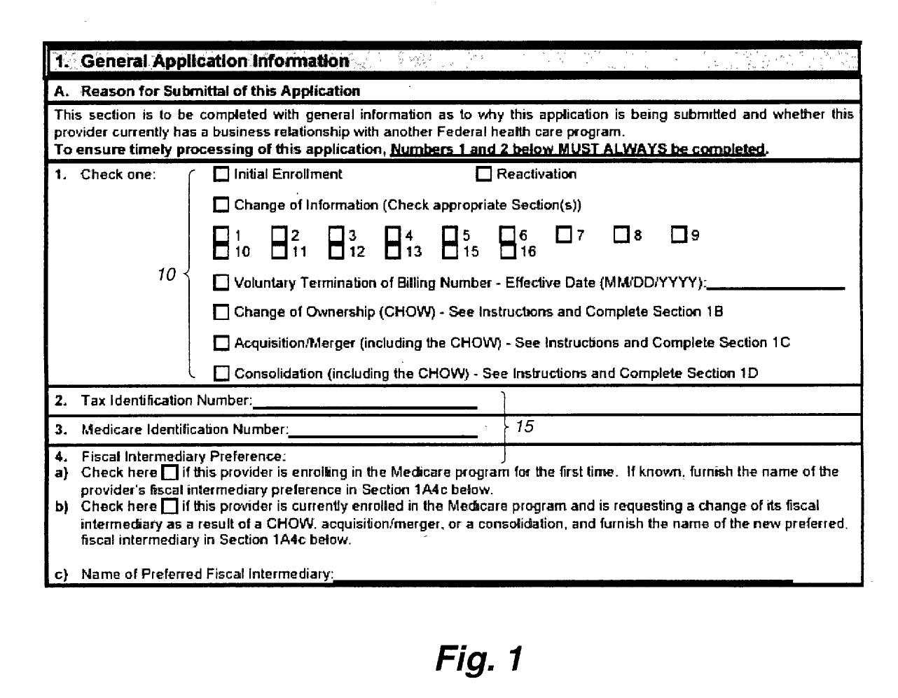

FIG. 1 shows the first data-entry section of the CMS's version of form 855A. Check boxes 10 and alphanumeric blanks 15 are typical of the fields that must be filled in.

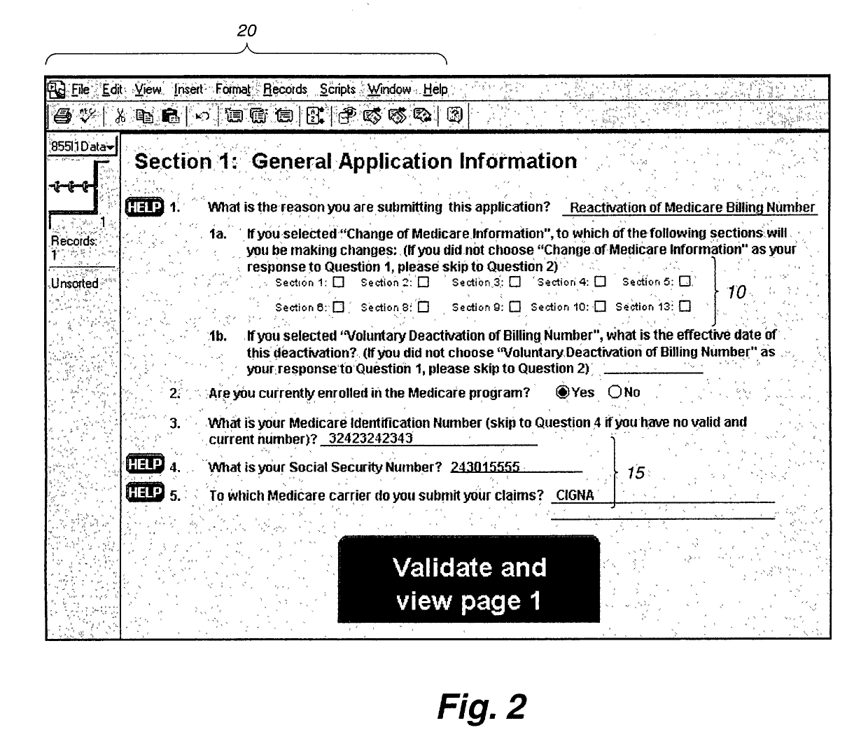

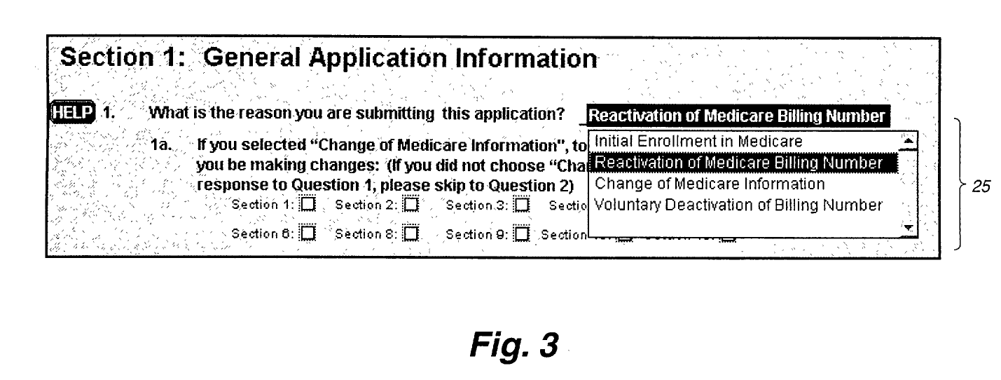

By comparison, FIG. 2 shows the first data-entry section of form 855I as it appears in the graphical user interface of the instant invention. The layout, while similar to the paper form, is much clearer. Check boxes 10 and alphanumeric data-entry fields 15 are shown, and appear similar to the way they appear in the actual form, as depicted in FIG. 1. Typical Windows-type menu commands are shown at 20. FIG. 3 illustrates another type of data-entry field, a drop-down box 25.

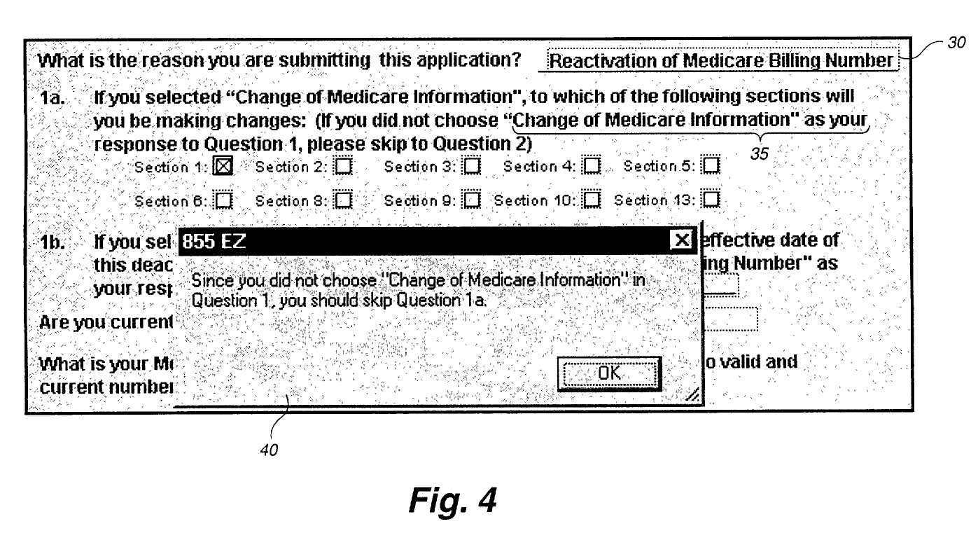

FIG. 4 exemplifies the present invention's data-validation feature. The user selected an item from the drop-down box at 30 that did not agree with the user's choice at field 35. In response, the program popped up the error message shown at 40. The error message not only notes that a mistake has been made, but tells the user what the mistake was and how to correct it.

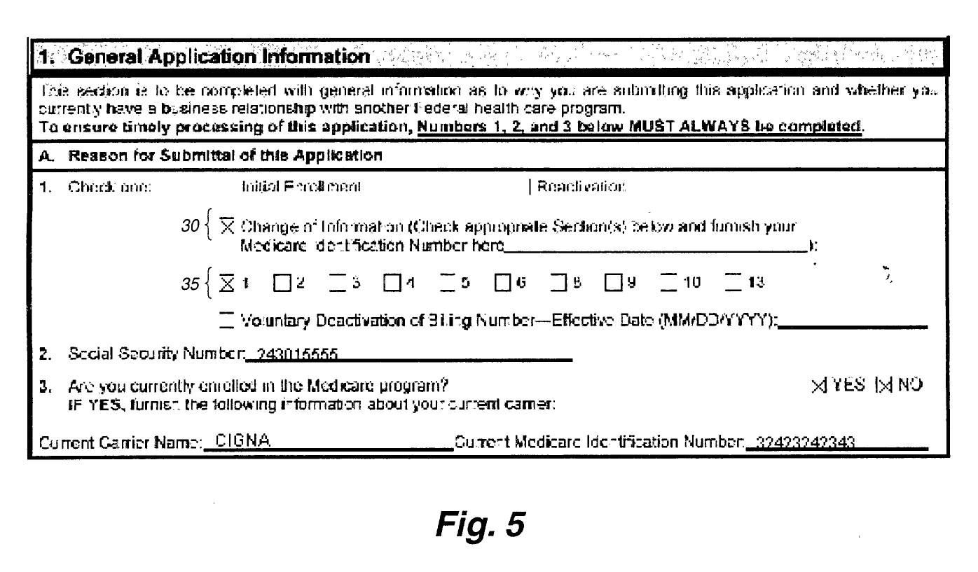

In FIG. 5, the user changed the selection in field 30 to match the choice in field 35. The software displayed a corrected form and allowed the user to continue.

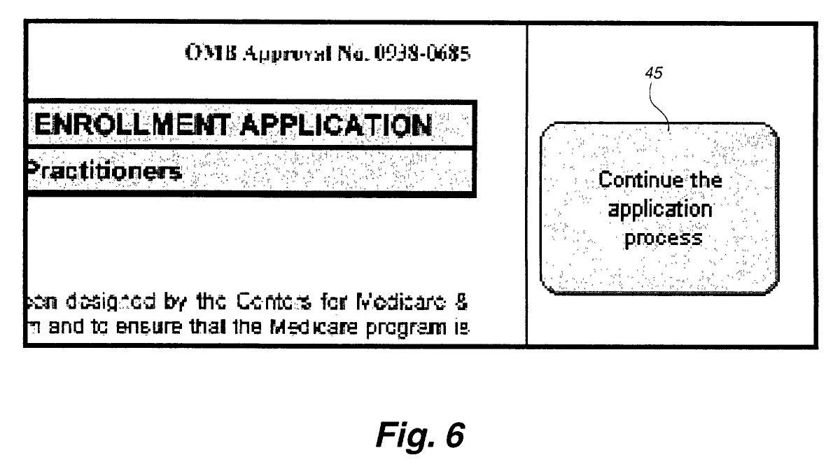

When the user is satisfied that a section of the form is correct, he or she has only to click a graphical button 45, as shown in FIG. 6, to return to a data-entry screen.

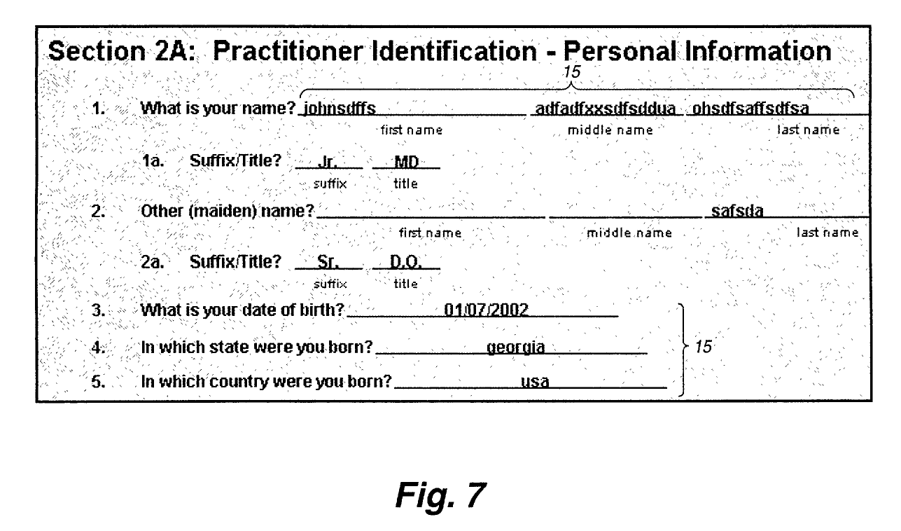

In FIG. 7, the user has satisfactorily completed the first section of the form, clicked the graphical continue button, returned to the next data-entry section, and filled in alphanumeric fields 15.

The present invention allows users to enter data by computer mouse clicks, voice commands, touch-sensitive screens, tactile-feedback devices, pointing devices, virtual-reality devices, instrument readings, medical monitoring devices, pre-recorded data, telemetry, and other techniques as may be developed.

The instant invention validates data entered into fields. Based on the inventor's expertise in the field of Medicare compliance, logic rules are applied to many of the fields within the forms. This logic is included in the programming behind the validation function of the program in the form of hundreds of if/then statements.

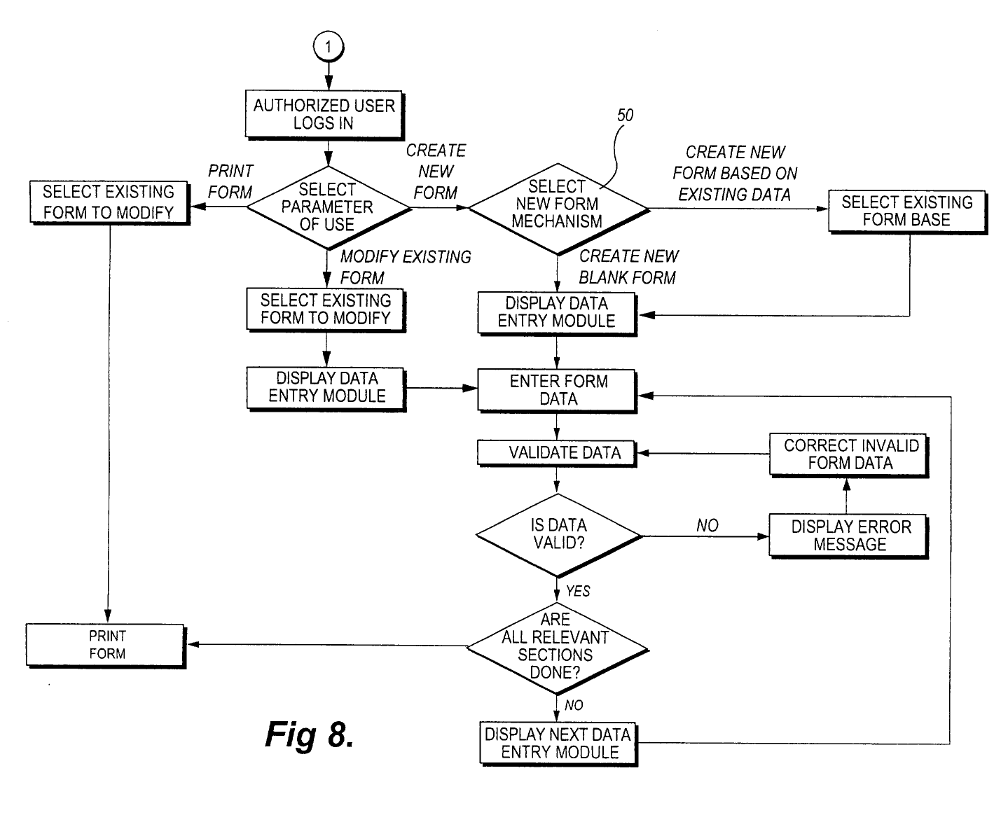

FIG. 8 is a logic flow chart illustrating major decision points in the software. FIG. 8 also illustrates how the program automatically fills in redundant data. At decision point 50, the software either creates a new form containing existing data or creates a new, blank form, if no there is no pre-existing data.

The instant invention delivers output in printed or electronic form in plain text, formatted text, HTML, e-mail, Web pages and parts thereof, artificial speech, sound, telemetry, data signals, color-coded graphics, database fields and records, input to medical monitoring devices and other equipment including telephones and computers, video images and signals, audio signals, data-transmission and switching devices, printed documents, polarized light, three-dimensional images, and other techniques as may be developed.

The instant invention will be distributed like other popular computer applications, on compact disc and other storage media. The software may be used on computers of all sizes and capacities.

It is to be understood that the present invention is not limited to the embodiment described above, but encompasses any and all embodiments within the scope of the following claims.

I claim:

1. A computerized system for filling out Medicare enrollment forms, comprising:
a) at least one computer having a processor, an area of main memory for executing program code under the direction of the processor, a storage device for storing data and program code and a bus connecting the processor and the storage device;
b) at least one relational database stored on said storage device;
c) a graphical user interface;
d) means of accessing the computerized system through its own graphical user interface and through World Wide Web browsers such as Microsoft Internet Explorer, Netscape, and Opera;
e) a data communications device connected to said bus for connecting said server computer to the Internet;
f) means of entering data, including, but not limited to, computer mouse, keyboard, voice commands, touch-sensitive screens, tactile-feedback devices, pointing devices, virtual-reality devices, electronic and optical instruments, pre-recorded data, and telemetry;
g) data output in paper, electronic, optical, and other forms;
h) computer program code stored in the above-noted storage device and executing in the main memory under the direction of the processor, the computer program including:
1) means for recording data on Centers for Medicare and Medicaid Service Medicare enrollment forms 855A, 855B, 855I, 855R, 855S, and other documents as may be required;
2) a graphical user interface of on-screen forms;
3) means of validating data entered by the user;
4) means of preventing the user from leaving a required data field empty;
5) means of alerting the user that the user made a mistake in data entry;
6) means of informing the user about the nature of a data-entry mistake made by the user;
7) means of informing the user about how to correct a data-entry mistake made by the user;
8) means of automatically inserting appropriate data in different fields within the same Medicare enrollment form and among different Medicare enrollment forms; and
9) means of manually inserting blocks of data consisting of more than one alphanumeric character in Medicare enrollment forms, at the direction of the user.

2. The computerized system according to claim 1, and including:
a) means for functioning on the Internet;
b) software that is independent of the computer platform; and
c) software that is scalable from the smallest medical organization to the largest medical organization.

3. A computer program product that includes a medium readable by a processor, the medium having stored thereon a set of instructions for medical management on an intranet, comprising:
a) a first sequence of instructions which, when executed by the processor, causes the processor to record data on Centers for Medicare and Medicaid Service Medicare enrollment forms 855A, 855B, 855I, 855R, 855S, and other documents as may be required;
b) a second sequence of instructions which, when executed by the processor, causes the processor to display a graphical user interface of on-screen forms;
c) a third sequence of instructions which, when executed by the processor, validates information entered by the user;
d) a fourth sequence of instructions which, when executed by the processor, causes the processor to prevent the user from omitting data from required fields;
e) a fifth sequence of instructions which, when executed by the processor, alerts the user that the user made a mistake in data entry;
f) a sixth sequence of instructions which, when executed by the processor, causes the processor to inform the user about the nature of a data-entry mistake made by the user;
g) a seventh sequence of instructions which, when executed by the processor, causes the processor to inform the user about how to correct a data-entry mistake made by the user;
h) an eighth sequence of instructions which, when executed by the processor, causes the processor to automatically insert appropriate data in different fields within the same Medicare enrollment form and among different Medicare enrollment forms; and
i) a ninth sequence of instructions which, when executed by the processor, causes the processor to manually insert blocks of data consisting of more than one alphanumeric character in Medicare enrollment forms, at the direction of the user.
